(19) United States
(12) Patent Application Publication
(10) Pub. No.: US 2003/0075226 A1
(43) Pub. Date: Apr. 24, 2003

(54) Insulated pipework system

(76) Inventors: Russell Codling, Northamptonshire (GB); Paul Summerfield, Leicestershire (GB)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 10/169,548

(22) PCT Filed: Jan. 5, 2001
(86) PCT No.: PCT/GB01/00037

(30) Foreign Application Priority Data
Jan. 7, 2000 (GB) 0000243.6

(51) Int. Cl. F16L 9/18

(52) U.S. Cl. 138/113; 138/112; 138/114; 138/149; 138/148

(57) ABSTRACT

An insulated pipework system comprises an outer sleeve, an inner flow pipe and one or more evacuated volumes in the space therebetween defined by annular plugs of a setting polymeric composition such as epoxy resin or a syntactic foam, typically at regular intervals along the length of the pipeline. The epoxy resins (for example) are ideally of sufficient rigidity to allow effective transfer of longitudinal forces between the inner and outer pipes. Thus, the evacuated volumes will themselves be annular. Other plugs of different orientation (for example longitudinal) could be included to subdivide the evacuated volumes further. The plugs allow the space between the pipes to be partitioned so that air can be evacuated from the sections so formed to provide the vacuum that acts as the insulating layer. Also, the plugs replace the need for bulkheads in that the partitioning of the inter-pipe space provides the desired water-stopping means. One or more coatings on the inside of the outer sleeve and/or the outside of the internal flow pipe can be provided, of a material that hinders the diffusion of hydrogen or other gases into the vacuum from either the surrounding water or the transported oil. The coating is typically an appropriate alloy, for example aluminium alloy. A plastics liner may also be suitable. Preferably, the vacuum enclosing surfaces are or are provided with a reflective material. This will minimise radiative heat transfer. Other coatings may include anticorrosion coatings. The inter-pipe space may also contain chemicals capable of absorbing gases (socalled “getters”) that would otherwise tend to accumulate within the vacuum.

### TECHNICAL FIELD OF THE INVENTION

The present invention relates to an improved system of pipelines for transporting crude oil and gas from off-shore extraction points. In particular, the present invention relates to such a system of pipes adapted to provide improved thermal insulation for transporting crude oil and gas (hereinafter collectively referred to as “oil”).

### BACKGROUND ART

Insulated pipeline systems conventionally consist of a double walled pipe comprising an inner flow line within an outer sleeve. The pipes are generally coaxial, and the annulus between the two pipes contains an insulating material.

Oil extracted from underground reservoirs is normally at an elevated temperature and the insulation serves to maintain it in that state. If the oil were to be allowed to cool, the higher melting point fractions would solidify and could potentially block the flow line. It is therefore necessary, in the design of such a pipe structure, to ensure that the insulating material provides sufficient insulation to maintain an adequate temperature along the entire length of the flow line.

In FIG. 1, a conventional double-walled pipe structure is shown that comprises an inner flow pipe (10) held concentrically within an outer sleeve pipe (12). Oil (14) flows within the flow pipe (10), and an insulating material (16) is placed in the annular region between the flow pipe (10) and the sleeve pipe (12). The entire assembly rests on the sea bed (18).

An inevitable result of maintaining the oil at elevated temperature is that at least the flow pipe (10) will be subjected to thermal expansion. This will result inter alia in either an extension of the longitudinal length of the pipeline, or an increase in the longitudinal compressive stress in the pipeline.

In order to ensure adequate transfer of longitudinal forces between the flow pipe (10) and the outer sleeve (12), a known solution has involved solid steel links between the two pipes at regular intervals. However, such links give rise to design difficulties, and in the system described in our earlier application now published as WO-A-96/36831, such links were omitted and replaced by bulkheads (32), as shown in FIG. 2. These were used to seal in place the insulating medium (16).

The use of regularly placed bulkheads also allows the space between the two pipes to be partitioned into sections. Any ingress of sea water through a rupture in the outer sleeve (12), due say to corrosion or mechanical damage, can be localised and so prevent substantial regions of insulating material (16) becoming saturated with water. In this way the majority of insulating material (16) can remain dry and thus retain its insulating properties.

Although known pipeline systems enable transportation of oil and/or gas from relatively less deep oil wells, particular disadvantages arise if they are considered for use in the transportation from relatively deeper wells. The deeper the pipeline is required to be, the greater the pressure the pipeline must be able to withstand. However, it is not effective to simply increase the thickness of the pipes, since this increases the dead weight of the pipeline, potentially to an extent that it cannot be easily assembled and laid from conventional laying boats.

Further, it is also necessary to maintain an adequate flow of oil and/or gas through the pipeline, and so simply reducing the diameter of the flow line is a similarly ineffective solution, if known constructions are used.

One possible solution would be to use pipeline in which the space between the two pipes is minimised, but two disadvantages are then incurred. Firstly, less insulating material can be used, whilst the demand for insulation increases with the lower temperatures found at greater depths. Secondly, it is difficult to insert bulkheads into a small inter-pipe space and so partitioning of the insulating material is prejudiced.

### SUMMARY OF THE INVENTION

It is an object of the present invention to provide a pipeline system that is suitable for the transportation of oil from relatively deep wells, in which the above disadvantages are alleviated.

Therefore, in one aspect, the present invention provides an insulated pipework system comprising an outer sleeve, an inner flow pipe and one or more evacuated volumes in the space therebetween defined by annular plugs of a setting polymeric composition, typically at regular intervals along the length of the pipeline.

Any known setting composition can be used, but those of sufficient rigidity to allow effective transfer of longitudinal forces between the inner and outer pipes are particularly preferred. Thus, the evacuated volumes will themselves be annular. Other plugs of different orientation (for example longitudinal) could be included to subdivide the evacuated volumes further.

The setting compositions provide a two-fold function. Firstly, they allow the space between the pipes to be partitioned so that air can be evacuated from the sections so formed to provide the vacuum that acts as the insulating layer. Secondly, they replace the need for bulkheads in that the partitioning of the inter-pipe space provides the desired water-stopping means, as discussed above.

Suitable setting compositions include a syntactic foam, available in low density mouldable forms, and epoxy resins. The composition can include a second phase, thereby forming a composite material. Suitable second phases include particulate insulating materials such as alumino-silicate microspheres (referred to in our earlier application, above).

A further preferred feature is one or more coatings on the inside of the outer sleeve and/or the outside of the internal flow pipe, of a material that hinders the diffusion of hydrogen or other gases into the vacuum from either the surrounding water or the transported oil. In particular, diffusion of hydrogen from the transported medium is a problem that may require redress depending on the oil composition and the specification of the pipe material.

Whereas the pipes are usually made of relatively inexpensive carbon steel, the coating is typically an appropriate alloy, for example aluminium alloy. A plastics liner may also be suitable.

The coating may be of differing thicknesses, depending upon the method of coating chosen for particular circumstances. Thus for thin layers of a few millimetres, the coating material may be melted into place. For thinner layers of a few microns, the coating may be sprayed onto the pipe surfaces. For very thin layers of micron or sub-micron thicknesses, sputter deposition techniques may be used.

Preferably, the vacuum enclosing surfaces are or are provided with a reflective material. This will minimise radiative heat transfer. Other coatings may include anti-corrosion coatings.

Typically, the space between the outer sleeve and inner flow pipe is 20 mm or less.

The inter-pipe space may also contain chemicals capable of absorbing gases (so-called “getters”) that would otherwise tend to accumulate within the vacuum.

### BRIEF DESCRIPTION OF THE DRAWINGS

The present invention will now be described by way of the following non-limiting example with reference to the accompanying drawings, in which:

FIG. 1 shows a conventional insulating dual pipe system;

FIG. 2 illustrates a pipeline having inter-pipe bulkheads, according to the prior art;

FIG. 3 depicts a pipeline having one or more inter-pipe sections containing a vacuum, according to the present invention;

FIG. 4 shows an individual epoxy plug in the inter-pipe space of the pipeline of FIG. 3; and

FIG. 5 illustrates an enlarged view of a coated pipeline according to the present invention.

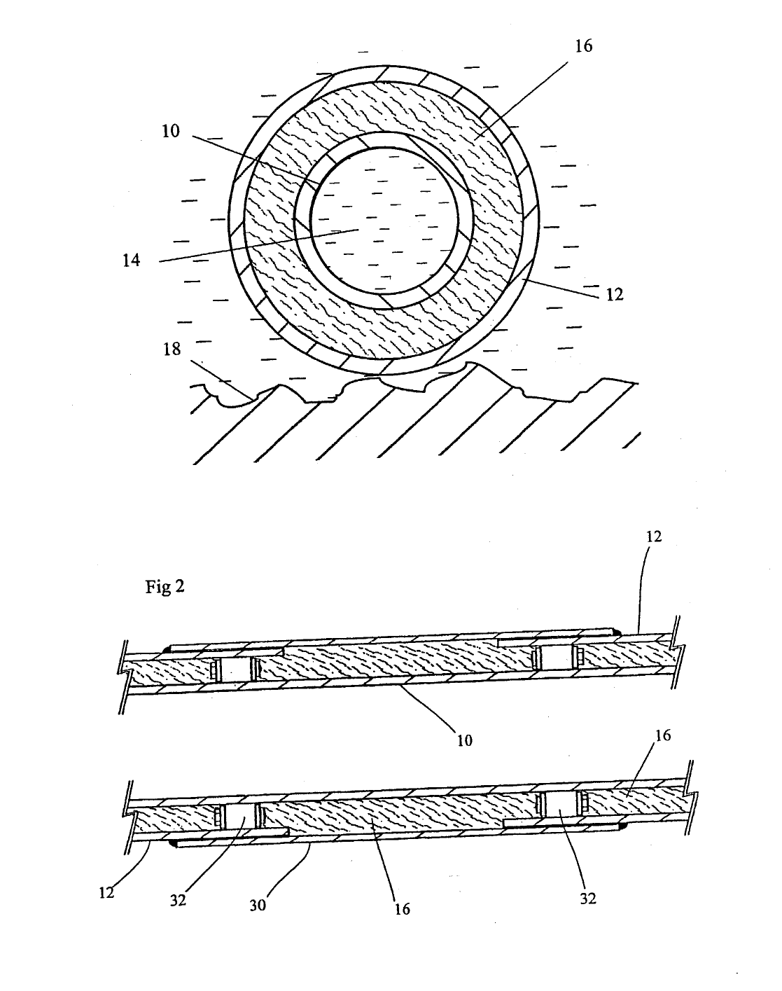

### DETAILED DESCRIPTION OF THE EXAMPLE

In FIG. 3, a pipeline is shown that comprises an outer sleeve (12) and an inner flow pipe (10), with (in this case) epoxy plugs (1) dividing the inter-pipe space into sections containing a vacuum (16). The outer sleeve (12) is coated on its inner surface with coatings (3) as described above, and the outer surface of the inner tube (10) is likewise coated (2).

Other materials can be used for the plugs, as set out above. Once cured, both epoxy resins and syntactic foams are suitable for operation at temperatures in excess of 150° C. and offer good thermal insulation. Thermal properties can be improved still further by including a second phase within the composition such as alumino-silicate microspheres, a known particulate insulation material. A second phase can also act as a filler/extender and improve mechanical properties such as toughness. A suitable syntactic foam is a phenolic composition manufactured by Alderley Materials under the brand name of ‘Contratherm’. The foam is mouldable and cures at ambient temperatures or just above to form a rigid structure. A preferred epoxy resin is Permabond™ DE244. When used with a microsphere filler, the resin occupies the interstitial voids between the spherical microspheres which hence exhibit a packing density of around 65%.

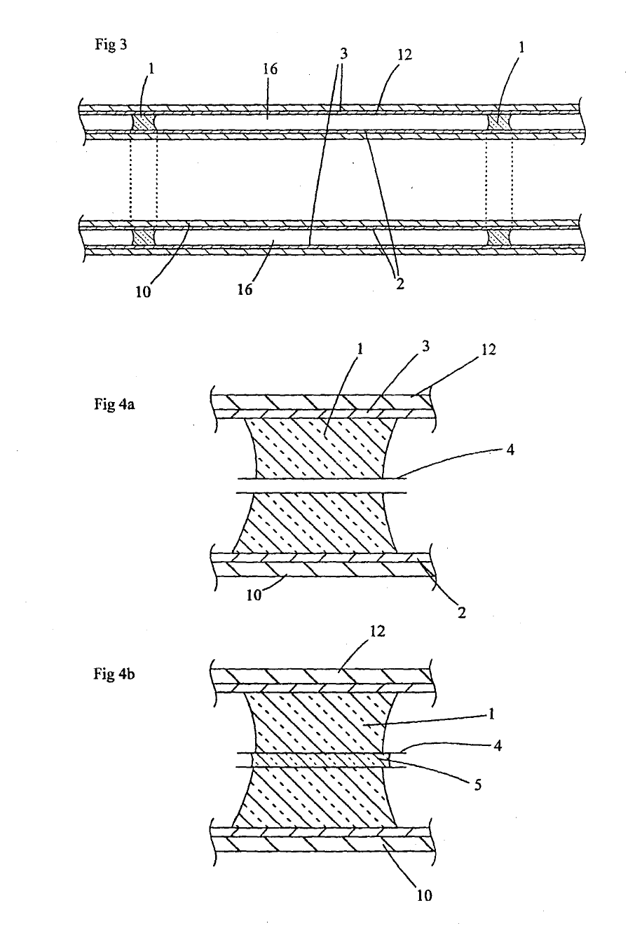

The vacuum in each section of inter-pipe space may be formed by plugging the space with epoxy resin plugs, each plug being constructed about a central tube (4), as shown in FIG. 4a, and then evacuating the air from each section through the respective tube. Once evacuation is complete, the central tube (4) may be plugged (5) itself with, for example, more epoxy resin, as shown in FIG. 4b. The nature of the epoxy resin or other setting composition allows easier evacuation and sealing of the internal section, combined with sufficient mechanical strength for use in the field.

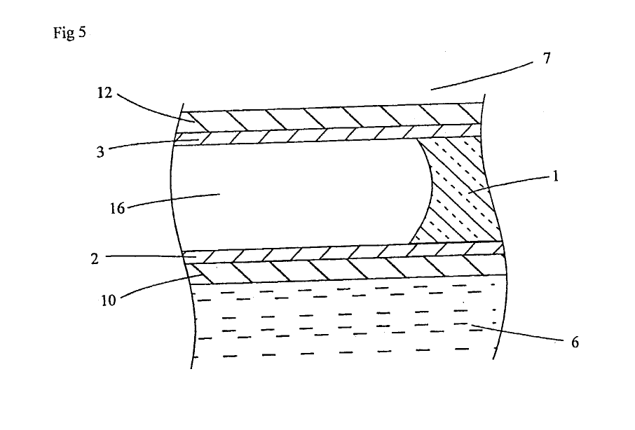

FIG. 5 shows an enlarged section of the pipeline shown in FIG. 3, with an outer sleeve (12) having a coating (3) and separated from the inner flow pipe (10) (also having a coating (2)) by an evacuated volume (16). Oil (6) is held within the inner flow pipe (10), whilst sea-water (7) surrounds the outer sleeve (12).

It will be appreciated by those skilled in the art that the above described embodiment is by way of example only, and that many variations can be made to the above embodiment without departing from the scope of the present invention.

The pipeline of the present invention provides a means for transporting oil and/or gas from relatively deep oil wells, without prejudicing flow rate, maintenance of the oil or gas temperature, or protection from ingress of water into the inter-pipe space.

1. An insulated pipework system comprising an outer sleeve, an inner flow pipe and one or more evacuated volumes in the space therebetween defined by annular plugs of a setting polymeric composition.

2. An insulated pipework system according to claim 1 in which the plugs are at regular intervals along the length of the pipeline.

3. An insulated pipework system according to claim 1 or claim 2 in which the polymeric composition is of sufficient rigidity to allow effective transfer of longitudinal forces between the inner and outer pipes.

4. An insulated pipework system according to any one of the preceding claims including further plugs of a different orientation to subdivide the evacuated volumes further.

5. An insulated pipework system according to claim 4 in which the further plugs are longitudinal with respect to the pipework.

6. An insulated pipework system according to any preceding claim in which the setting polymeric composition is one of an epoxy resin and a syntactic foam.

7. An insulated pipework system according to any preceding claim in which the setting polymeric composition includes a second phase.

8. An insulated pipework system according to claim 7 in which the second phase is a particulate insulating material.

9. An insulated pipework system according to claim 8 in which the insulating material is alumino-silicate microspheres.

10. An insulated pipework system according to any preceding claim including at least one coating on the inside of the outer sleeve and/or the outside of the internal flow pipe, the coating being of a material that hinders the diffusion of gas into the vacuum.

11. An insulated pipework system according to claim 10 in which the coating is a metallic alloy.

12. An insulated pipework system according to claim 11 in which the coating is an aluminium alloy.

13. An insulated pipework system according to claim 10 in which the coating consist of a plastics liner.

14. An insulated pipework system according to any one of claims 10 to 13 in which the coating material is melted into place.

15. An insulated pipework system according to any one of claims 10 to 13 in which the coating material is sprayed onto the pipe surfaces.

16. An insulated pipework system according to any one of claims 10 to 13 in which the coating material is deposited by a sputter or ion techniques.

17. An insulated pipework system according to any preceding claim in which the vacuum enclosing surfaces are or are provided with a reflective material.

18. An insulated pipework system according to any preceding claim in which the inter-pipe space contains chemicals capable of absorbing gases.

19. An insulated pipework system substantially as herein described with reference to and/or as illustrated in the accompanying drawings.
